(19) United States
(12) Patent Application Publication
(10) Pub. No.: US 2026/0269133 A1
(43) Pub. Date: Sep. 10, 2026

(54) MULTILAYER CERAMIC ELECTRONIC COMPONENT, AND PRODUCTION METHOD OF MULTILAYER CERAMIC ELECTRONIC COMPONENT

(71) Applicant: TAIYO YUDEN CO., LTD., Tokyo (JP)

(72) Inventors: Wakaaki MURAI, Tokyo (JP); Satoshi KOBAYASHI, Tokyo (JP); Taiga SAITO, Gunma (JP); Chizuru TADOKORO, Gunma (JP); Seiya SUGAI, Tokyo (JP)

(21) Appl. No.: 19/454,725

(22) Filed: Jan. 21, 2026

(30) Foreign Application Priority Data
Mar. 7, 2025 (JP) 2025-036840

(51) Int. Cl. H01G 4/30; H01G 4/232

(52) U.S. Cl. CPC H01G 4/30; H01G 4/2325

(57) ABSTRACT

A multilayer ceramic electronic component includes a body including internal electrodes and dielectric layers alternately laminated, and facing end surfaces, the dielectric layers including a ceramic as a main component; a metal base layer in contact with at least a portion of the internal electrodes exposed from at least one of the end surfaces of the body, and disposed at an end portion of a surface of the body connected to the at least one end surface, the end portion being on an end-surface side of the body; an insulating layer disposed opposite to the at least one end surface across an end of the metal base layer at the end portion; and a plating layer disposed at the end portion such that the metal base layer and the insulating layer are sandwiched between the plating layer and the body, and forming an external electrode with the metal base layer.

### CROSS-REFERENCE TO RELATED APPLICATIONS

This patent application is based on and claims priority to Japanese Patent Application No. 2025-036840 filed on Mar. 7, 2025, the entire contents of which are incorporated herein by reference.

### TECHNICAL FIELD

The present disclosure relates to a multilayer ceramic electronic component, and a production method of the multilayer ceramic electronic component.

### BACKGROUND

An external electrode in a multilayer ceramic electronic component, such as a multilayer ceramic capacitor or the like, includes a metal base layer in contact with a body and a plating layer covering the metal base layer. The external electrode is known to contain, between the outermost plating layer and the body, at least one of an element forming a covalent hydride with hydrogen, or an element forming a hydride in a boundary region with hydrogen (see, for example, Patent Document 1). It is known that there is an Sn-deposited region between a metal base layer and an Ni plating layer (see, for example, Patent Document 2).

### RELATED ART DOCUMENT

### Patent Document

Patent Document 1: Japanese Laid-Open Patent Application Publication No. 2016-058719
Patent Document 2: International Publication No. WO2024/047980

### SUMMARY

An embodiment of the present disclosure is a multilayer ceramic electronic component including: a body that includes a plurality of internal electrodes and a plurality of dielectric layers, and includes end surfaces facing each other, in which each of the plurality of dielectric layers includes a ceramic as a main component, and the plurality of internal electrodes and the plurality of dielectric layers are alternately laminated; a metal base layer that is in contact with at least a portion of the plurality of internal electrodes exposed from at least one end surface of the end surfaces of the body, and is disposed at an end portion of a surface of the body connected to the at least one end surface, the end portion being on an end-surface side of the body; an insulating layer that is disposed opposite to the at least one end surface across an end of the metal base layer at the end portion; and a plating layer disposed at the end portion such that the metal base layer and the insulating layer are sandwiched between the plating layer and the body, the plating layer forming an external with the metal base layer.

Another embodiment of the present disclosure is a production method of a multilayer ceramic electronic component including: providing a body that includes a plurality of internal electrodes and a plurality of dielectric layers, and includes end surfaces facing each other, in which each of the plurality of dielectric layers includes a ceramic as a main component, and the plurality of internal electrodes and the plurality of dielectric layers are alternately laminated; forming a metal base layer that is in contact with at least a portion of the plurality of internal electrodes exposed from at least one end surface of the end surfaces of the body, and is disposed at an end portion of a surface of the body connected to the at least one end surface, the end portion being on an end-surface side of the body; forming an insulating layer that is disposed opposite to the at least one end surface across an end of the metal base layer at the end portion; and forming a plating layer disposed at the end portion such that the metal base layer and the insulating layer are sandwiched between the plating layer and the body, the plating layer forming an external electrode with the metal base layer.

### BRIEF DESCRIPTION OF THE DRAWINGS

FIG. 1 is a partial cross-sectional perspective diagram of a multilayer ceramic capacitor according to a first embodiment.

FIG. 2 is a cross-sectional diagram taken along the line A-A of FIG. 1.

FIG. 3 is a cross-sectional diagram taken along the line B-B of FIG. 1.

FIG. 4 is a cross-sectional diagram of an end portion in the first embodiment.

FIG. 5 is a flowchart illustrating a production method of the multilayer ceramic capacitor in the first embodiment.

FIG. 6 is a cross-sectional diagram of an end portion in a first comparative embodiment.

FIG. 7 is a cross-sectional diagram of a multilayer ceramic capacitor according to a second embodiment.

FIG. 8A, FIG. 8B, FIG. 8C, FIG. 8D, and FIG. 8E are cross-sectional diagrams illustrating a production method of the multilayer ceramic capacitor of the second embodiment.

FIG. 9A, FIG. 9B, and FIG. 9C are cross-sectional diagrams of an end portion in the production method of the multilayer ceramic capacitor of the second embodiment.

FIG. 10 is a cross-sectional diagram of an end portion in a second comparative embodiment.

FIG. 11 is a cross-sectional diagram of an end portion in Modified Example 1 of the second embodiment.

FIG. 12 is a cross-sectional diagram of an end portion in Modified Example 2 of the second embodiment.

FIG. 13 is a cross-sectional diagram of an end portion in Modified Example 3 of the second embodiment.

FIG. 14 is a cross-sectional diagram of an end portion in Modified Example 4 of the second embodiment.

FIG. 15A, FIG. 15B, and FIG. 15C are cross-sectional diagrams of an end portion in a production method of a multilayer ceramic capacitor of a third embodiment.

### DETAILED DESCRIPTION

A plating layer contains a large amount of hydrogen. Diffusion of the hydrogen in the plating layer into the body causes, for example, reduction of a dielectric layer, resulting in degradation in the characteristics.

According to the present disclosure, it is possible to provide a multilayer ceramic electronic component in which diffusion of hydrogen into a body is suppressed, and a production method of the multilayer ceramic electronic component.

Hereinafter, embodiments of the present disclosure will be described in detail below. However, the present disclosure is not limited to the embodiments described below. In the present specification and drawings, components having substantially the same functional configuration are denoted by the same reference signs, and thus duplicate description thereof may be omitted.

### First Embodiment

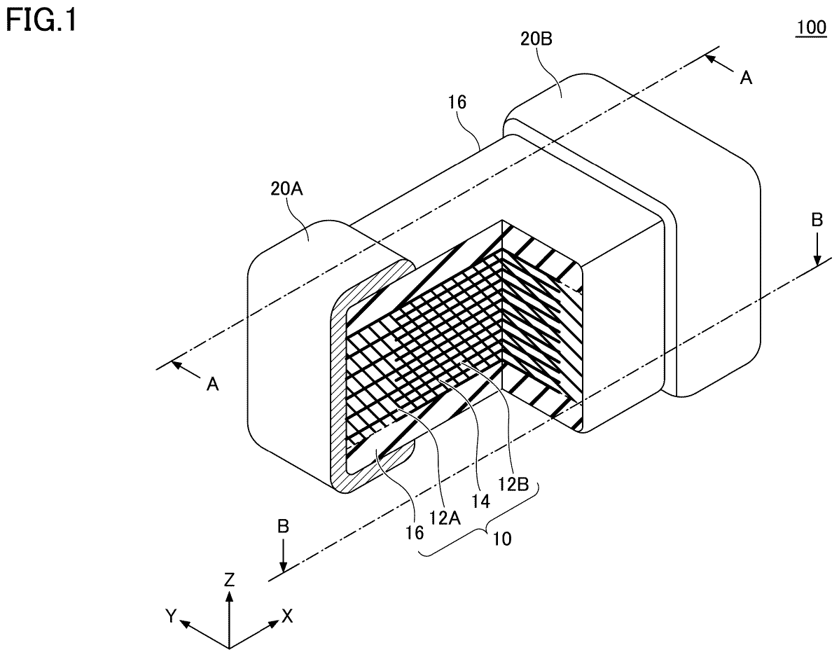

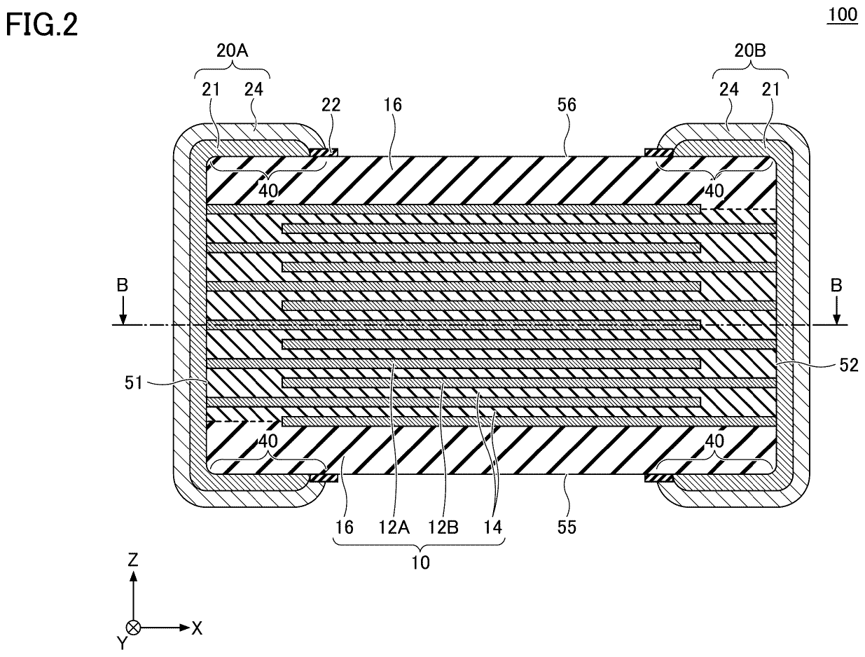

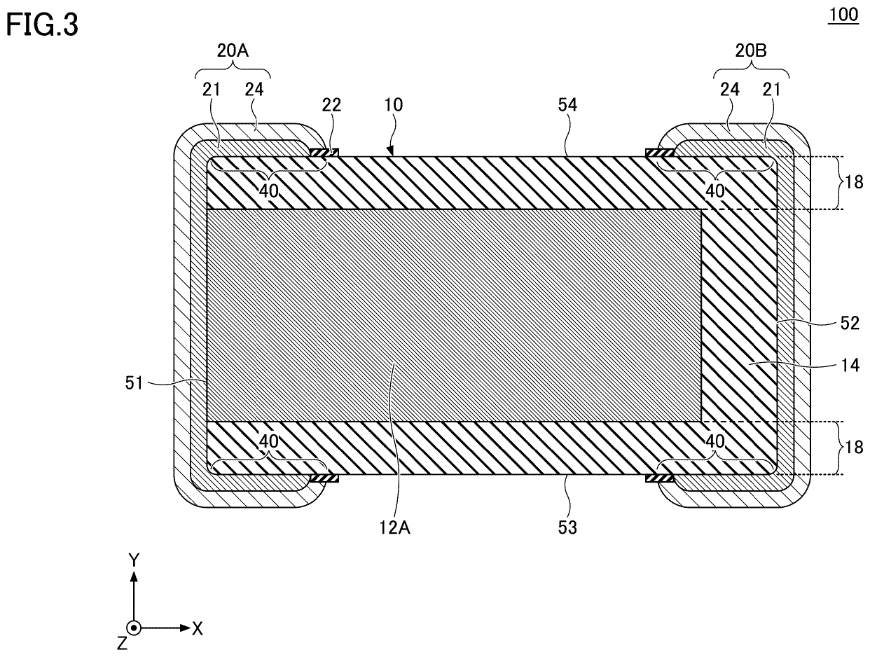

A multilayer ceramic capacitor will be described as an example of the multilayer ceramic electronic component. FIG. 1 is a partial cross-sectional perspective diagram of a multilayer ceramic capacitor 100 according to a first embodiment. FIG. 2 is a cross-sectional diagram taken along the line A-A of FIG. 1. FIG. 3 is a cross-sectional diagram taken along the line B-B of FIG. 1.

In FIGS. 1 to 3, a Z direction (first direction) is a lamination direction in which dielectric layers 14, internal electrodes 12A, and internal electrodes 12B are laminated, i.e., a direction in which a bottom surface 55 and a top surface 56 of a body 10 face each other. An X direction (second direction) is a lengthwise direction of the body 10, i.e., a direction in which a pair of end surfaces 51 and 52 of the body 10 face each other. A Y direction (third direction) is a widthwise direction of the internal electrodes 12A and the internal electrodes 12B, i.e., a direction in which a pair of side surfaces 53 and 54 of the body 10 face each other. The X direction, the Y direction, and the Z direction cross each other or are orthogonal to each other.

The multilayer ceramic capacitor 100 includes: the body 10 having a substantially rectangular parallelepiped shape; and external electrodes 20A and 20B. The body 10 includes a plurality of dielectric layers 14, a plurality of internal electrodes 12A and 12B, and a cover dielectric layer 16. The plurality of internal electrodes 12A and the plurality of internal electrodes 12B are alternately laminated. One of the plurality of dielectric layers 14 is disposed between one of the plurality of internal electrodes 12A and one of the plurality of internal electrodes 12B. The outermost layers, in the Z direction, of a laminate including the dielectric layers 14, the internal electrodes 12A, and the internal electrodes 12B are the internal electrode 12A and the internal electrode 12B. The bottom surface and the top surface of the laminate are covered by the cover dielectric layer 16. Regions sandwiching the plurality of internal electrodes 12A and 12B in the Y direction are side margin regions 18.

The internal electrodes 12A and 12B are alternately exposed from the end surfaces 51 and 52. The internal electrodes 12A are exposed from the end surface 51, and the internal electrodes 12B are not exposed from the end surface 51. The internal electrodes 12B are exposed from the end surface 52, and the internal electrodes 12A are not exposed from the end surface 52. That is, the internal electrodes 12A and 12B are connected to different end surfaces 51 and 52.

The external electrode 20A is in contact with the internal electrodes 12A exposed from the body 10 in the end surface 51. The external electrode 20B is in contact with the internal electrodes 12B exposed from the body 10 in the end surface 52. In addition to the end surface 51, the external electrode 20A covers the side surfaces 53 and 54 and end portions 40 in an −X direction of the bottom surface 55 and the top surface 56. In the surfaces connected to the end surfaces 51 and 52 of the body 10, the end portions 40 are portions on the end surface 51 side and on the end surface 52 side (close to the end surfaces 51 and 52). The external electrode 20B is in contact with the internal electrodes 12B in the end surface 52. In addition to the end surface 52, the external electrode 20B covers the side surfaces 53 and 54 and the end portions 40 in an +X direction of the bottom surface 55 and the top surface 56.

Each of the external electrodes 20A and 20B includes a metal base layer 21 and a plating layer 24. The plating layer 24 covers the metal base layer 21. On the side surfaces 53 and 54, the bottom surface 55, and the top surface 56, insulating layers 22 are disposed opposite to the end surfaces 51 and 52 across the ends of the metal base layers 21. The insulating layers 22 prevent the plating layer 24 from contacting the body 10.

The size of the multilayer ceramic capacitor 100 may be, for example: 0.25 mm in length (length in the X direction), 0.125 mm in width (width in the Y direction), and 0.125 mm in height (height in the Z direction); 0.4 mm in length, 0.2 mm in width, and 0.2 mm in height; 0.6 mm in length, 0.3 mm in width, and 0.3 mm in height; 1.0 mm in length, 0.5 mm in width, and 0.5 mm in height; 3.2 mm in length, 1.6 mm in width, and 1.6 mm in height; or 4.5 mm in length, 3.2 mm in width, and 2.5 mm in height. The size of the multilayer ceramic capacitor 100 is not limited to these sizes.

The internal electrodes 12A and 12B contain, as a main component, a base metal, such as nickel (Ni), copper (Cu), tin (Sn), or the like. The internal electrodes 12A and 12B may contain a noble metal, such as platinum (Pt), palladium (Pd), silver (Ag), gold (Au), or the like, or an alloy containing these. The thickness of the internal electrode 12A or 12B is, for example, 0.1 micrometers (μm) or more and 1 μm or less.

The dielectric layers 14 contain, as a main phase, a ceramic material having a perovskite structure represented by general formula ABO₃. The perovskite structure includes ABO_{3-α} that deviates from the stoichiometric composition. The ceramic material for use can be, for example, at least one selected from barium titanate (BaTiO₃), calcium zirconate (CaZrO₃), calcium titanate (CaTiO₃), strontium titanate (SrTiO₃), magnesium titanate (MgTiO₃), and Ba_{1-x-y}CaₓSr_{y}Ti_{1-z}Zr_{z}O₃ (0≤x≤1, 0≤y≤1, 0≤z≤1) forming the perovskite structure. Ba_{1-x-y}CaₓSr_{y}Ti_{1-z}Zr_{z}O₃ is barium strontium titanate, barium calcium titanate, barium zirconate, barium zirconate titanate, calcium zirconate titanate, barium calcium zirconate titanate, or the like. For example, the dielectric layers 14 contain the main component ceramic in an amount of 90 atomic % or more. The thickness of the dielectric layer 14 is, for example, 0.3 μm or more and 2 μm or less.

Additives may be added to the dielectric layer 14. Examples of the additives to be added to the dielectric layer 14 include: oxides of zirconium (Zr), hafnium (Hf), magnesium (Mg), manganese (Mn), molybdenum (Mo), vanadium (V), chromium (Cr), rare earth elements (yttrium (Y), samarium (Sm), europium (Eu), gadolinium (Gd), terbium (Tb), dysprosium (Dy), holmium (Ho), erbium (Er), thulium (Tm), and ytterbium (Yb)); oxides containing cobalt (Co), nickel (Ni), lithium (Li), boron (B), sodium (Na), potassium (K), or silicon (Si); and glass containing cobalt, nickel, lithium, boron, sodium, potassium, or silicon.

The composition of the main component ceramic of the cover dielectric layer 16 may be the same as or different from the main component ceramic of the dielectric layer 14.

The metal base layer 21 contains, as a main component, a metal, such as copper, nickel, aluminum (Al), zinc (Zn), or the like, or an alloy of two or more of these (e.g. an alloy of copper and nickel). Additionally, the metal base layer 21 contains a glass component for densifying the metal base layer 21, and a ceramic, such as a co-existing material for controlling sinterability of the external electrodes 20A and 20B. The glass component includes an oxide of silicon, and may also include an oxide of barium (Ba), strontium (Sr), calcium (Ca), zinc, aluminum, boron, or the like. The thickness of the metal base layer 21 is, for example, 3 μm or more and 50 μm or less.

The plating layer 24 contains, as a main component, a metal, such as copper, nickel, aluminum, zinc, tin, or the like, or an alloy of two or more of these. The plating layer 24 may be a plating layer containing a single metal component, or may be a plurality of plating layers containing different metal components. Further, a film of a conductive resin, such as an epoxy resin, a urethane resin, or the like, may be formed over the surface of the plating layer 24. The thickness of the plating layer 24 is, for example, 5 μm or more and 15 μm or less.

The insulating layer 22 contains, as a main component, silicon oxide, tin oxide, titanium oxide, tantalum oxide, aluminum oxide, niobium oxide, iron oxide, silicon nitride, tin nitride, titanium nitride, or tantalum nitride, or two or more of these. The insulating layer 22 may be a glass layer. The thickness of the insulating layer 22 is, for example, 10 nm or more and 1,000 nm or less.

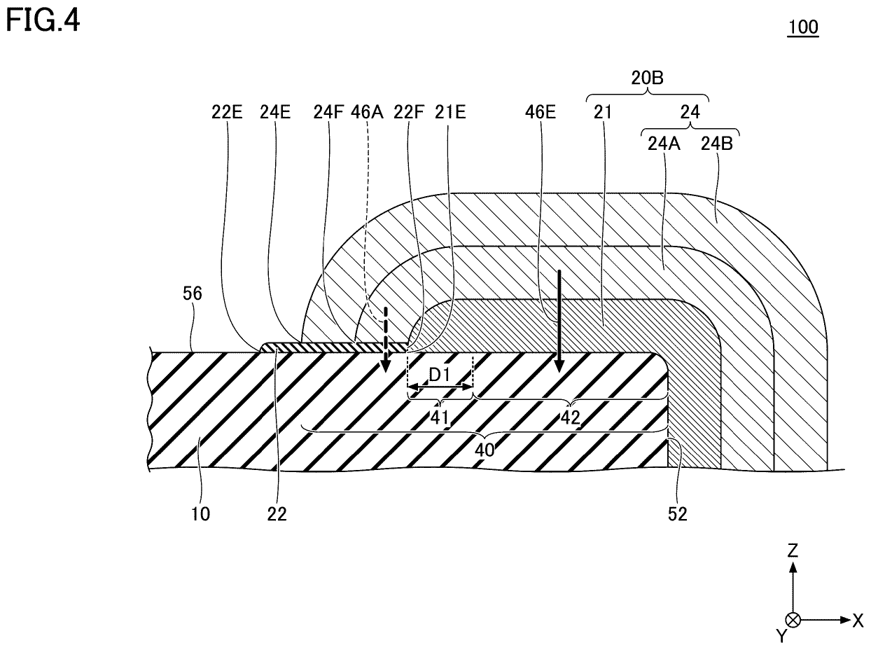

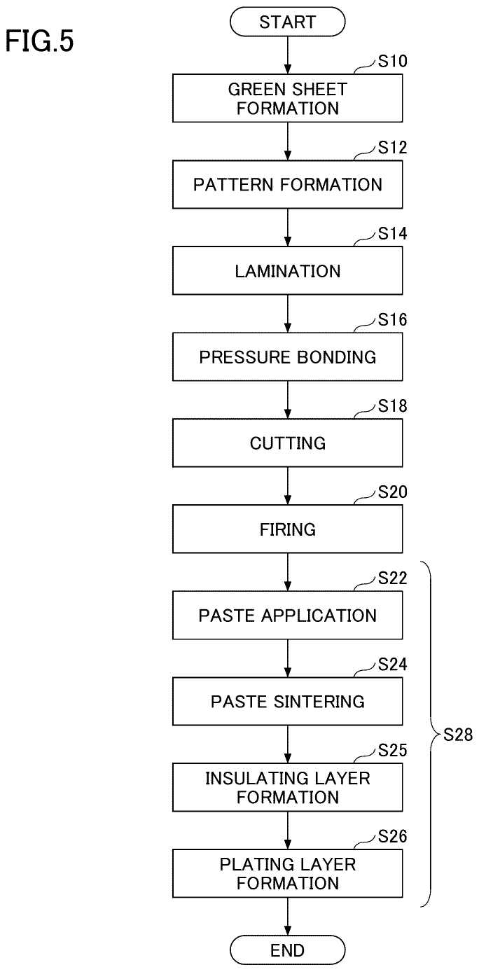

FIG. 4 is a cross-sectional diagram of the end portion in the first embodiment. As illustrated in FIG. 4, the insulating layer 22 is disposed on an −X side (opposite to the end surface 52) of an end 21E of the metal base layer 21 at the end portion 40. An end 22F of the insulating layer 22 on the end surface 52 side contacts the end 21E of the metal base layer 21. That is, the insulating layer 22 does not extend between the body 10 and the metal base layer 21. An insulator different from the insulating layer 22 may be located between the body 10 and the metal base layer 21. The recitation that the end 22F of the insulating layer 22 is in contact with the end 21E of the metal base layer 21 includes the end 22F and the end 21E not exactly coinciding with each other. For example, a portion of the insulating layer 22 may be disposed between the metal base layer 21 and the body 10 in a region 41 extending from the end 21E of the metal base layer 21 toward the end surface 52 by a distance D1. The insulating layer 22 is not disposed between the metal base layer 21 and the body 10 in a region 42 apart from the end 21E of the metal base layer 21 toward the end surface 52 by the distance D1 or more. For example, the distance D1 is preferably 1 μm or less, more preferably 0.5 μm or less, and further preferably 0.1 μm or less.

The plating layers 24 are disposed over the metal base layer 21 and the insulating layer 22. The plating layers 24 include a first layer 24A and a second layer 24B. An end 24E of the plating layers 24 is located between the end 21E of the metal base layer 21 and an end 22E of the insulating layer 22. An end 24F of the first layer 24A is located between the end 24E and the end 21E. The insulating layer 22 is disposed between the plating layers 24 and the body 10. Thus, the plating layers 24 are not in contact with the body 10.

The metal base layer 21 contains copper or the like as a main component. The first layer 24A contains nickel or the like as a main component. The second layer 24B contains tin or the like as a main component. The second layer 24B is a layer to be soldered when the multilayer ceramic capacitor 100 is mounted by soldering.

### Production Method of First Embodiment

A production method of the multilayer ceramic capacitor 100 will be described. FIG. 5 is a flowchart illustrating the production method of the multilayer ceramic capacitor 100 in the first embodiment.

### Green Sheet Formation Step

First, a green sheet is formed (step S10). In step S10, a dielectric material is prepared, for example, by adding various additive compounds (e.g., a sintering aid) to a ceramic powder. A binder, such as a polyvinyl butyral (PVB) resin or the like, an organic solvent, such as ethanol, toluene, or the like, and a plasticizer are added to the prepared dielectric material, and mixed in a wet manner to form a slurry. Using the formed slurry, a green sheet is coated on a base by a die coater method, a doctor blade method, or the like. The base is, for example, a PET (polyethylene terephthalate) film. Then, the green sheet is dried.

### Pattern Formation Step

Subsequently, metal patterns to be the internal electrodes 12A and 12B are formed on the green sheet (step S12). In step S12, an organic binder-containing conductor paste for the formation of the internal electrodes is printed on the green sheet on the base through gravure printing or the like. Thus, a plurality of metal patterns corresponding to the internal electrodes 12A and 12B are formed on the green sheet in a state of being apart from each other. The conductor paste contains a metal powder, serving as a main component, such as a nickel powder or the like, a binder, and an organic solvent. Ceramic particles may be added to the conductor paste as a co-existing material.

### Lamination Step

Subsequently, the green sheets are laminated (step S14). In step S14, a laminated sheet is formed by laminating the green sheets on which the metal patterns to be the internal electrodes 12A and 12B have been printed. The green sheets corresponding to the cover dielectric layers 16 are respectively laminated on both end surfaces of the laminated sheet in the lamination direction.

### Pressure-Bonding Step

Subsequently, the laminated sheet is pressure-bonded (step S16). In step S16, the laminated sheet formed in step S14 is pressed to pressure-bond the green sheets. For the pressure bonding, for example, an isostatic press is used.

### Cutting Step

Subsequently, the laminated sheet is cut (step S18). In step S18, a plurality of the bodies 10 are disposed by cutting the laminated sheet in the lamination direction along a predetermined cut line by a cutting blade. In each of the bodies 10, the internal electrodes 12A are exposed from the end surface 51, and the internal electrodes 12B are exposed from the end surface 52. After step S18, the body 10 may be polished through barrel polishing or the like. Thus, the corners of the body 10 are rounded.

### Firing Step

Subsequently, the body 10 is fired (step S20). In step S20, the body 10 is subjected to a debinder treatment in a nitrogen gas atmosphere at 250° C. or higher and 500° C. or lower, and then fired in a reducing atmosphere at 1,300° C. or higher and 1,400° C. or lower for about 1 hour. Thus, the particles of the body 10 and the internal electrodes 12A and 12B are sintered.

### External Electrode Formation Step

Subsequently, the external electrodes 20A and 20B are formed (step S28). Step S28 includes steps S22, S24, S25, and S26.

First, a paste is applied to the body 10 (step S22). In step S22, for example, the paste is applied to the end portions 40 and the end surface 51 of the body 10, for example, by a dip method. The paste contains metal particles, serving as a main component, glass particles (glass frits), a binder, and an organic solvent.

Next, the paste is sintered (step S24). In step S24, the paste to be a raw material for the metal base layer 21 is baked in a nitrogen atmosphere of 750° C. or higher and 850° C. or lower, which is lower than the firing temperature in step S20. Thus, the paste is sintered to form the metal base layer 21. The body 10 and the paste may be sintered in step S24 without performing the firing in step S20. The sintering conditions in this case are the same as those in step S20.

Next, the insulating layer 22 is formed (step S25). The formation method of the insulating layer 22 will be described in a second embodiment and a third embodiment. Next, the plating layer 24 is formed (step S26). In step S26, the plating layer 24 is formed on the metal base layer 21.

### First Comparative Embodiment

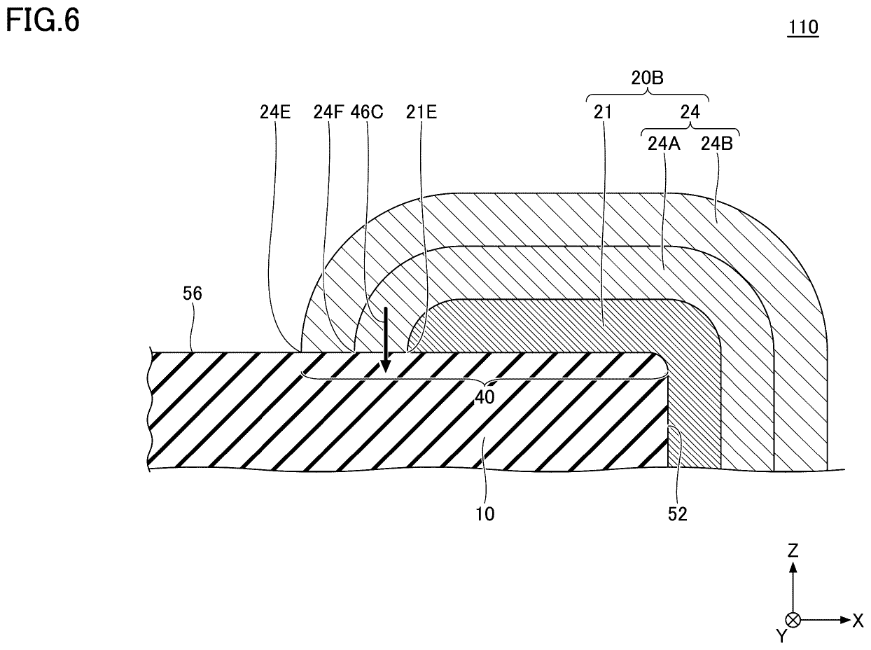

FIG. 6 is a cross-sectional diagram of an end portion in a first comparative embodiment. As illustrated in FIG. 6, a multilayer ceramic capacitor 110 of the first comparative embodiment does not include the insulating layer 22. On the −X side of the end 21E of the metal base layer 21, the plating layers 24 contact the body 10. The plating layers 24 contain a large amount of hydrogen. As indicated by a solid-line arrow 46C, hydrogen (or hydrogen ions H⁺) diffuses from the plating layers 24 into the body 10. Especially, when the first layer 24A contains nickel as a main component, a large amount of hydrogen is contained in the first layer 24A due to the ability of nickel to store hydrogen. The hydrogen reaches the internal electrode 12A or 12B, then diffuses into the internal electrodes 12A and 12B, and then diffuses into the dielectric layer 14 facing the internal electrodes 12A and 12B. Reduction of the dielectric layer 14 due to hydrogen causes degradation in characteristics, such as, for example, generation of a leakage current between the internal electrodes 12A and 12B.

### Description of First Embodiment

In the first embodiment, as illustrated in FIG. 4, the insulating layer 22 is disposed on the −X side (opposite to the end surface 52) of the end 21E of the metal base layer 21 at the end portion 40. The plating layer 24 is disposed at the end portion 40 such that the metal base layer 21 and the insulating layer 22 are sandwiched between the plating layer 24 and the body 10. Thus, the insulating layer 22 can suppress diffusion of hydrogen into the body 10 as indicated by a dotted-line arrow 46A, thereby suppressing degradation in characteristics, such as a leakage current or the like. The surface on which the insulating layer 22 is disposed opposite to the end surface 52 across the end 21E of the metal base layer 21 at the end portion 40 may be at least one selected from the side surfaces 53 and 54, the bottom surface 55, and the top surface 56.

The first layer 24A is a nickel plating layer containing nickel as a main component. The insulating layer 22 is disposed between the first layer 24A and the body 10, and thus the first layer 24A does not contact the body 10. This can further suppress diffusion, into the body 10, of hydrogen from the first layer 24A in which hydrogen is stored.

### Second Embodiment

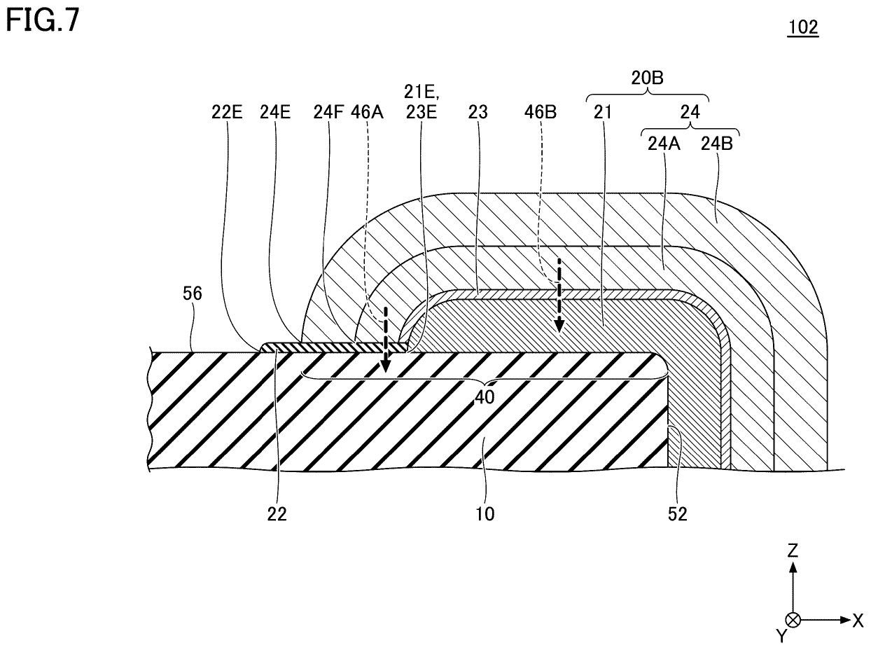

A second embodiment is an example for describing a specific formation method of the insulating layer 22. FIG. 7 is a cross-sectional diagram of an end portion in the second embodiment. As illustrated in FIG. 7, a multilayer ceramic capacitor 102 of the second embodiment includes a metal layer 23. The metal layer 23 covers the metal base layer 21. At the end 21E of the metal base layer 21, the metal layer 23 and the insulating layer 22 are in contact with each other. The end 21E of the metal base layer 21 and an end 23E of the metal layer 23 substantially coincide with each other. The end 24E of the plating layer 24 is located between the end 21E of the metal base layer 21 and the end 22E of the insulating layer 22. Thus, the insulating layer 22 is disposed between the plating layers 24 and the body 10, and the plating layers 24 are not in contact with the body 10. Other configurations are the same as those of FIG. 4 of the first embodiment, and description thereof is omitted.

### Production Method of Modified Example 1 of Second Embodiment

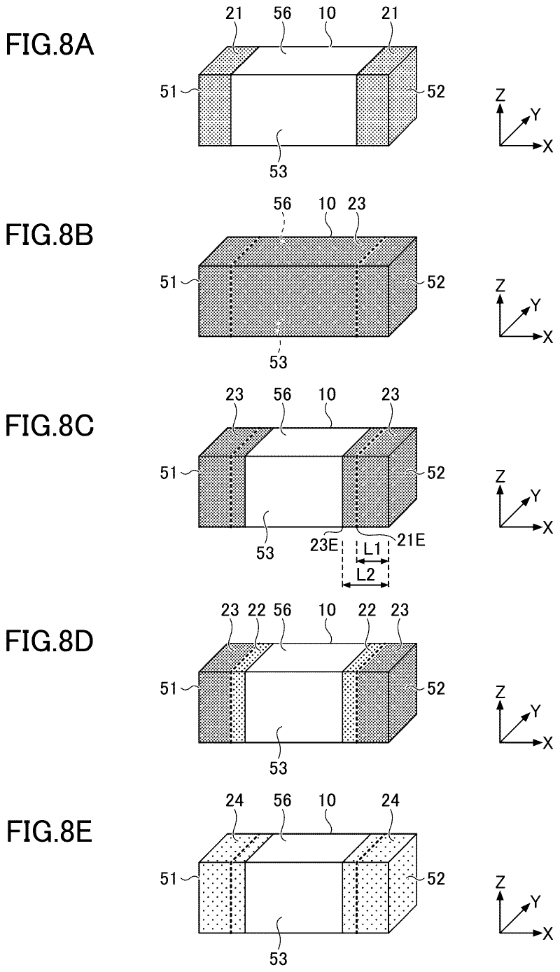

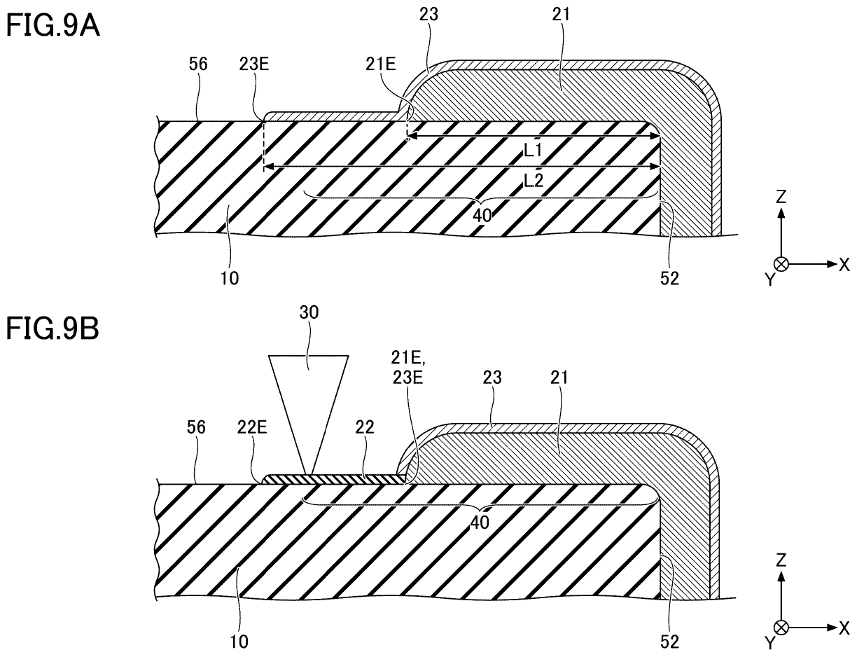

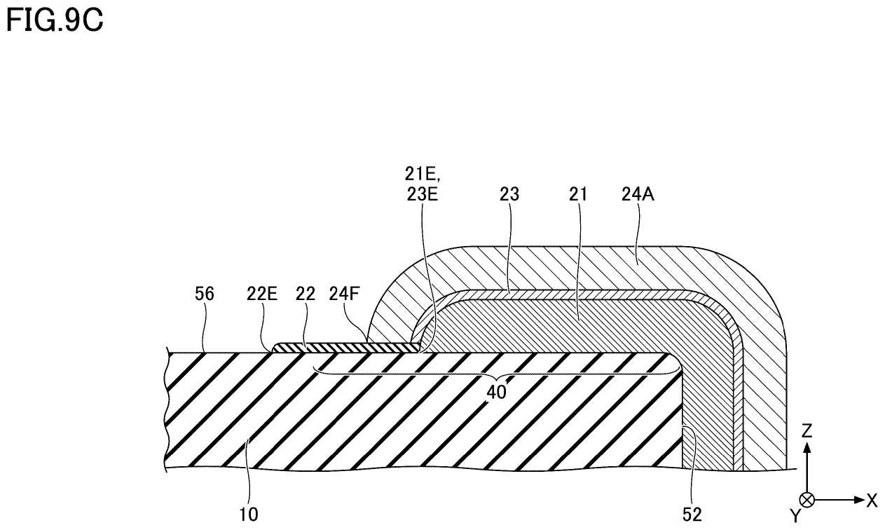

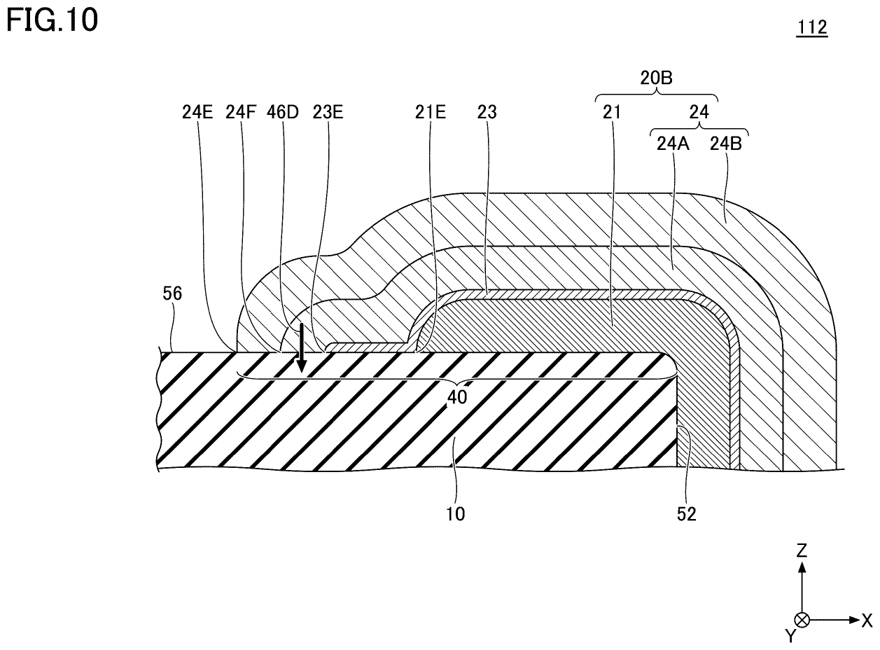

FIGS. 8A to 8E are perspective diagrams illustrating a production method of a multilayer ceramic capacitor of the second embodiment. FIGS. 9A to 9C are cross-sectional diagrams of end portions in the production method of the multilayer ceramic capacitor of the second embodiment.

In step S24 of FIG. 5, as illustrated in FIG. 8A, a paste is sintered to form the metal base layers 21 on the body 10.

Next, in step S25 of FIG. 5, the insulating layers 22 are formed. First, as illustrated in FIG. 8B, the metal layer 23 is formed on the body 10 and the metal base layer 21. The metal layer 23 is formed on all six faces of the body 10. A sputtering method is used to form the metal layer 23. The sputtering method is, for example, a powder sputtering method. The powder sputtering method is a method of forming a sputtering film on the surfaces of particles of powder. By using the body 10 including the metal base layers 21 instead of the powder, the metal layer 23 is formed on all the six faces of the body 10.

Next, as illustrated in FIGS. 8C and 9A, the metal layer 23 at the center of the body 10 in the X direction is removed. A distance L2 between the end 23E of the metal layer 23 and the end surface 52 in the X direction is made greater than a distance L1 between the end 21E of the metal base layer 21 and the end surface 52 in the X direction. Thus, the tip of the metal layer 23 contacts the body 10. A method of removing a portion of the metal layer 23 is, for example, a laser trimming method.

Next, as illustrated in FIGS. 8D and 9B, the tip of the metal layer 23 is irradiated with laser light 30 to partially heat the metal layer 23 and oxidize the metal layer 23. This changes the tip of the metal layer 23 to the insulating layer 22. The end 23E of the metal layer 23 substantially coincides with the end 21E of the metal base layer 21. By lowering the output of the laser light 30, the metal layer 23 can be oxidized without ablating the metal layer 23, compared to the case of laser trimming. The laser light can be ultraviolet laser light, green laser light, YAG (Yttrium Aluminum Garnet) laser light, or CO₂ laser light.

Next, in step S26 of FIG. 5, the plating layer 24 is formed. As illustrated in FIG. 9C, the first layer 24A is formed using the metal layer 23 as a seed layer by an electroless plating method. Since the resistivity of the insulating layer 22 is high, the first layer 24A is not formed using the insulating layer 22 as a seed layer. Therefore, the first layer 24A is formed in the −X direction starting from the end 23E of the metal layer 23. Thus, the first layer 24A is formed on the insulating layer 22, i.e., the first layer 24A is not formed in contact with the body 10.

Next, the second layer 24B is formed on the first layer 24A through plating. As illustrated in FIGS. 8E and 7, the plating layer 24 is formed to cover the metal layer 23. The second layer 24B is formed in the −X direction starting from the end 24F of the first layer 24A. Thus, the second layer 24B is formed on the insulating layer 22, i.e., the second layer 24B is not formed in contact with the body 10. The metal base layer 21, the metal layer 23, and the plating layer 24 form the external electrodes 20A and 20B.

### Second Comparative Embodiment

FIG. 10 is a cross-sectional diagram of an end portion in a second comparative embodiment. As illustrated in FIG. 10, in a multilayer ceramic capacitor 112 according to the second comparative embodiment, the insulating layer 22 in FIG. 9B is not formed.

When the first layer 24A is formed through plating, the metal layer 23 serves as a seed layer, and the first layer 24A is formed. The first layer 24A is formed in the −X direction starting from the end 23E of the metal layer 23. Therefore, the first layer 24A is formed in contact with the body 10 on the −X side of the end 23E of the metal layer 23. The second layer 24B is formed in the −X direction starting from the end 24F of the first layer 24A. Therefore, the second layer 24B is formed in contact with the body 10.

In this manner, the first layer 24A and the second layer 24B are formed in contact with the body 10. Therefore, hydrogen diffuses from the plating layers 24 into the body 10 as indicated by a solid-line arrow 46D, resulting in degradation in characteristics, such as a leakage current or the like.

In the first embodiment illustrated in FIG. 4, when the material of the metal base layer 21 is, for example, nickel, which readily causes diffusion of hydrogen, hydrogen in the plating layer 24 diffuses through the metal base layer 21 into the body 10 as indicated by a solid-line arrow 46E. This causes degradation in characteristics, such as a leakage current or the like.

### Description of Second Embodiment

In the second embodiment, as illustrated in FIG. 7, the metal layer 23 is disposed between the metal base layer 21 and the plating layers 24, and is continuous with the insulating layer 22. In this configuration, the insulating layer 22 can suppress diffusion of hydrogen from the plating layer 24 into the body 10 as indicated by the dotted-line arrow 46A, thereby suppressing degradation in characteristics, such as a leakage current or the like. Further, the metal layer 23 can suppress diffusion of hydrogen from the plating layers 24 into the body 10 through the metal base layer 21 as indicated by a dotted-line arrow 46B, thereby suppressing degradation in characteristics, such as a leakage current or the like.

As illustrated in FIG. 9A, the metal layer 23 is formed to cover the metal base layer 21 and the body 10 on the −X side of the end 21E of the metal base layer 21 at the end portion 40. As illustrated in FIG. 9B, a region on the −X side of the end 21E of the metal layer 23 is irradiated with the laser light 30, thereby oxidizing the metal layer 23. By forming the metal layer 23 and the insulating layer 22 in this manner, the metal layer 23 and the insulating layer 22 are formed to be continuous with each other.

When tin is used as the main component of the metal layer 23, as illustrated in FIG. 9B, heating at 220° C. or higher in the air oxidizes tin to form the insulating layer 22 containing tin oxide (e.g., SnO₂) as a main component. Also, the resistivity of tin oxide is five orders of magnitude larger than the resistivity of tin. Thus, when the first layer 24A is formed through plating using the metal layer 23 as a seed layer in FIG. 9C, the first layer 24A is not formed starting from the insulating layer 22. Therefore, it is possible to suppress contact between the first layer 24A and the body 10 as illustrated in FIG. 10.

The metal layer 23 is preferably a metal in which diffusion of hydrogen does not readily occur. From this viewpoint, the metal layer 23 may contain, as a main component, titanium, molybdenum, magnesium, or the like. In FIG. 9B, a method of oxidizing the metal layer 23 using the laser light 30 is described. Alternatively, a region of the metal layer 23 on the −X side of the end 21E may be subjected to selective oxidation or nitridation. The insulating layer 22 formed in this manner contains a metal element, which is the main component of the metal layer 23. The insulating layer 22 contains, as a main component, an oxide or nitride of the metal element. The insulating layer 22 may be formed from the metal layer 23 by a method other than oxidation or nitridation.

### Modified Example 1 of Second Embodiment

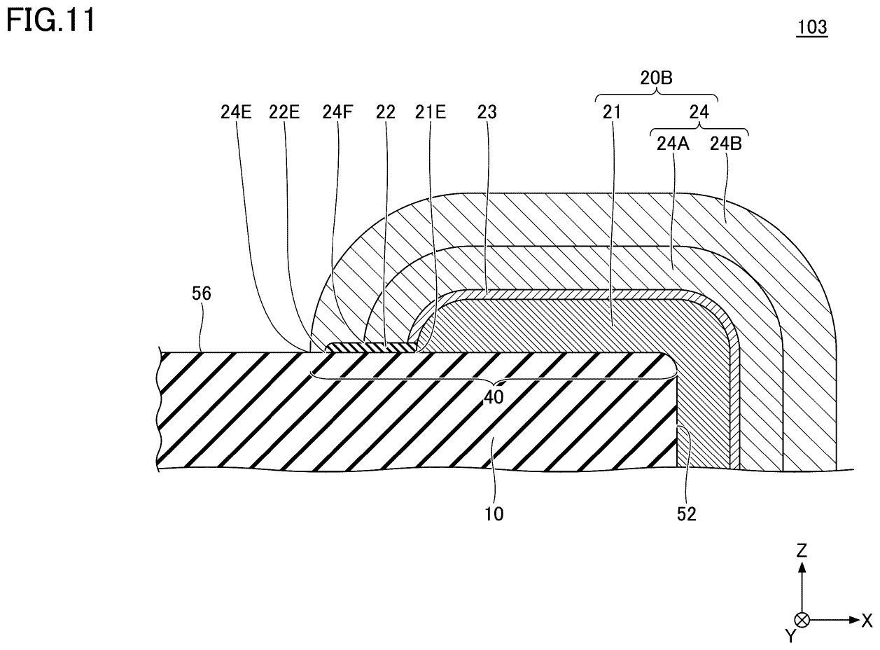

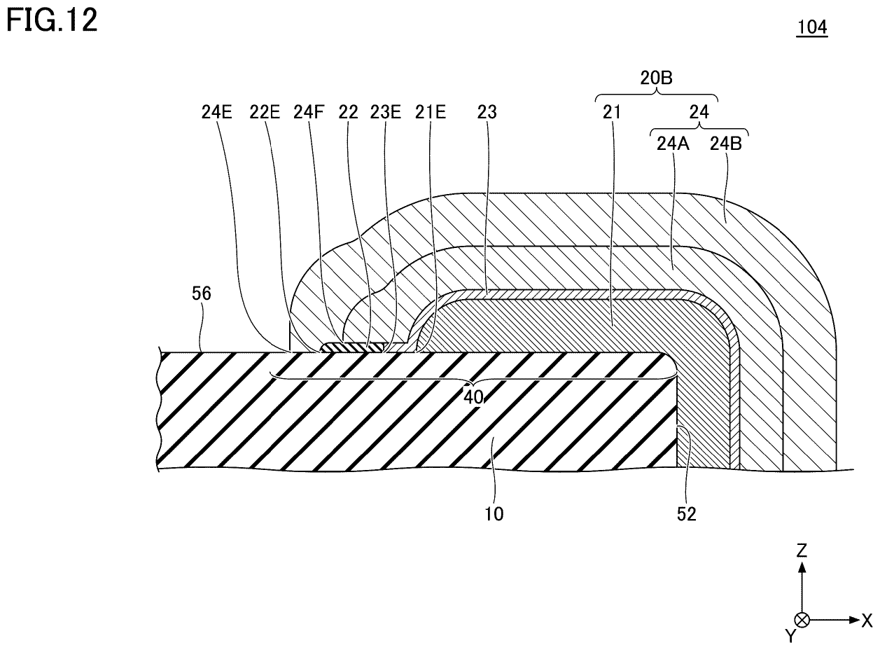

FIG. 11 is a cross-sectional diagram of an end portion in Modified Example 1 of the second embodiment. As illustrated in FIG. 11, in a multilayer ceramic capacitor 103 of Modified Example 1 of the second embodiment, the end 22E of the insulating layer 22 is located between the end 24E of the plating layer 24 and the end 24F of the first layer 24A. A portion of the second layer 24B is in contact with the body 10, but the first layer 24A is not in contact with the body 10. Other configurations are the same as those of FIG. 7 of the second embodiment, and description thereof is omitted.

### Modified Example 2 of Second Embodiment

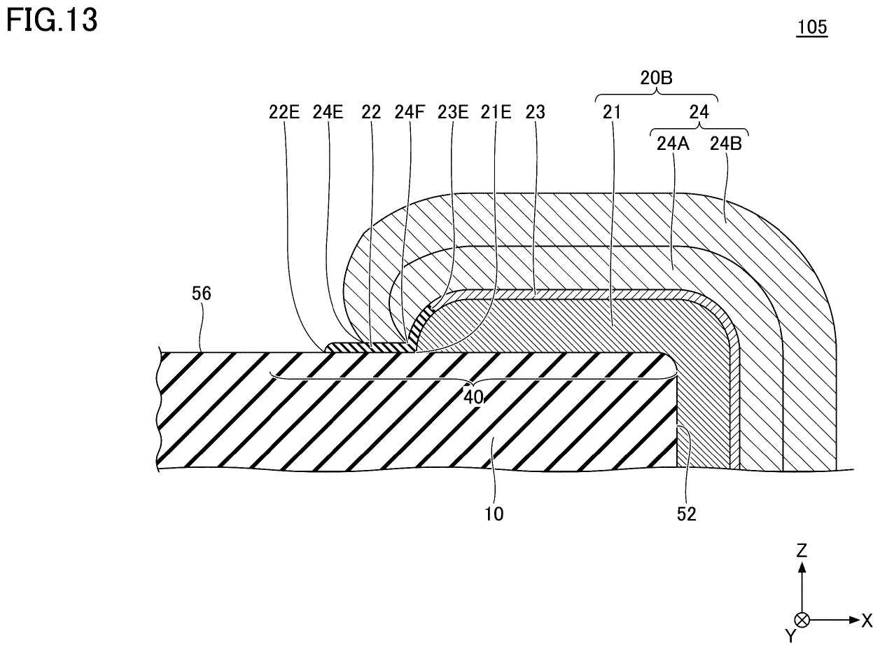

FIG. 12 is a cross-sectional diagram of an end portion in Modified Example 2 of the second embodiment. As illustrated in FIG. 12, in a multilayer ceramic capacitor 104 of Modified Example 2 of the second embodiment, the end 23E of the metal layer 23 is located on the −X side of the end 21E of the metal base layer 21. A portion of the metal layer 23 is in contact with the body 10. The insulating layer 22 and the metal layer 23 are sandwiched between the first layer 24A and the body 10. Other configurations are the same as those of FIG. 7 of the second embodiment, and description thereof is omitted.

### Modified Example 3 of Second Embodiment

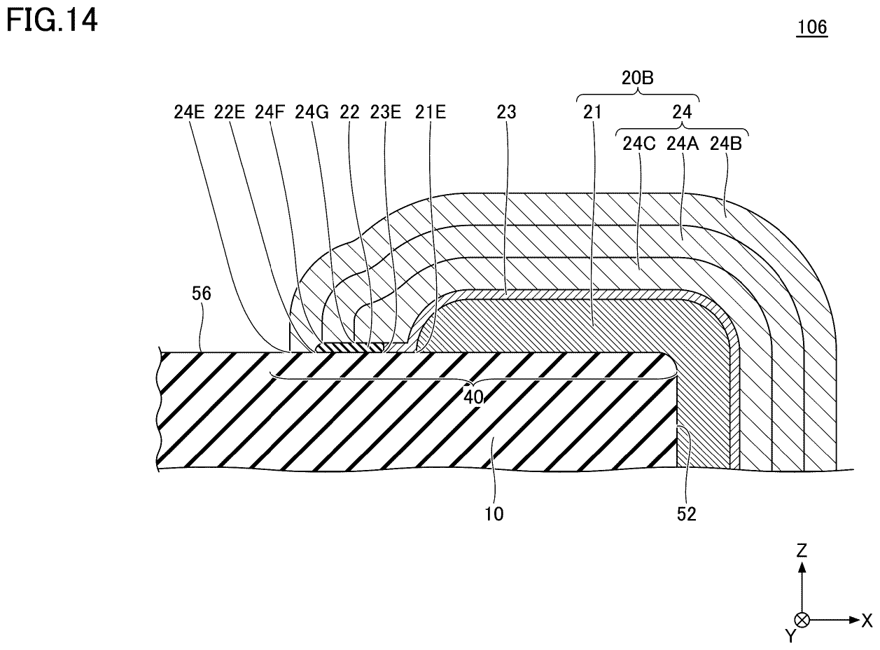

FIG. 13 is a cross-sectional diagram of an end portion in Modified Example 3 of the second embodiment. As illustrated in FIG. 13, in a multilayer ceramic capacitor 105 of Modified Example 3 of the second embodiment, the end 23E of the metal layer 23 is located on the surface of the metal base layer 21. Thus, the first layer 24A is formed in the −X direction and the −Z direction starting from the end 23E of the metal layer 23. Therefore, the end 24F of the first layer 24A is located on the insulating layer 22 formed on the body 10, or is located on the insulating layer 22 formed on the surface of the metal base layer 21. Other configurations are the same as those of FIG. 7 of the second embodiment, and description thereof is omitted.

### Modified Example 4 of Second Embodiment

FIG. 14 is a cross-sectional diagram of an end portion in Modified Example 4 of the second embodiment. As illustrated in FIG. 14, in a multilayer ceramic capacitor 106 of Modified Example 4 of the second embodiment, the plating layers 24 include a third layer 24C. The third layer 24C is disposed between the first layer 24A and the metal layer 23. A portion of the metal layer 23 is disposed on the body 10. A portion of the second layer 24B is in contact with the body 10. An end 24G of the third layer 24C and the end 23E of the first layer 24A are located between the end 22E of the insulating layer 22 and the end 23E of the metal layer 23. Thus, the insulating layer 22 is disposed between the first layer 24A and the body 10, i.e., the first layer 24A is not in contact with the body 10.

The metal base layer 21 contains nickel or the like as a main component. The third layer 24C contains copper or the like as a main component. The first layer 24A contains nickel or the like as a main component. The second layer 24B contains tin or the like as a main component. Direct plating of the first layer 24A containing nickel as a main component is not readily performed on the metal base layer 21 containing nickel as a main component. Thus, the third layer 24C contains, as a main component, copper, which is readily directly plated on the metal base layer 21. The first layer 24A containing nickel as a main component is readily plated on the third layer 24C containing copper as a main component. Other configurations are the same as those of the second embodiment, and description thereof is omitted.

The first layer 24A containing nickel as a main component stores hydrogen. Therefore, as illustrated in FIGS. 11, 12, and 14 of Modified Examples 1, 2, and 4 of the second embodiment, if the first layer 24A is not in contact with the body 10, at least a portion of the second layer 24B not containing nickel as a main component may be in contact with the body 10. In this manner, at least a portion of the plating layer 24 other than the first layer 24A containing nickel as a main component may be in contact with the body 10. This can reduce a range of the metal layer 23 to be changed to the insulating layer 22. Therefore, for example, it is possible to reduce a range irradiated with the laser light 30, and reduce the number of production steps.

As illustrated in FIGS. 12 and 14 of Modified Examples 2 and 4 of the second embodiment, a portion of the metal layer 23 may be disposed on the body 10. As illustrated in FIG. 13 of Modified Example 3 of the second embodiment, a portion of the insulating layer 22 may be disposed on the surface of the metal base layer 21.

### Third Embodiment

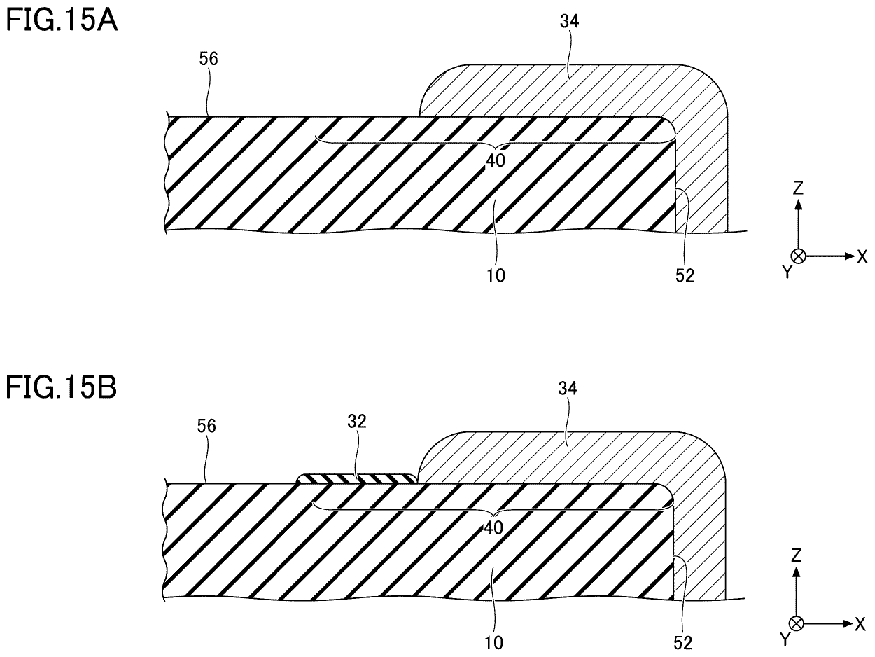

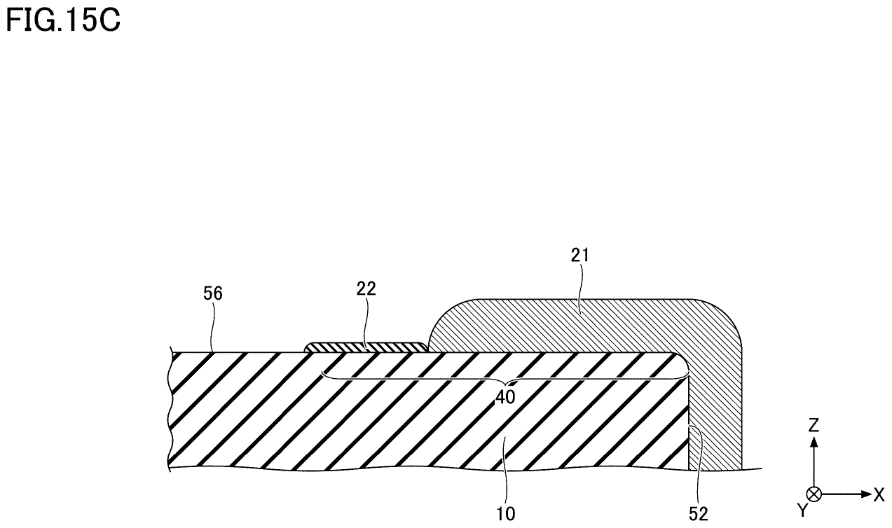

A third embodiment is another example for describing a specific formation method of the insulating layer 22. FIG. 15A to FIG. 15C are cross-sectional diagrams of an end portion in a production method of a multilayer ceramic capacitor of the third embodiment.

In step S22 of FIG. 5, as illustrated in FIG. 15A, a paste 34 is applied to the end portion 40 and the end surface 52, for example, by a dip method. The paste 34 contains metal particles, serving as a main component, glass particles, a binder, and an organic solvent.

Next, a paste 32 is applied to a portion of the end portion 40 of the body 10 illustrated in FIG. 15B. The paste 32 contains no metal powder, and contains a glass powder containing silicon oxide, a binder, and an organic solvent. The glass powder may contain at least one metal oxide selected from barium oxide, zinc oxide, calcium oxide, aluminum oxide, magnesium oxide, boron oxide, and the like.

In step S24 of FIG. 5, sintering is performed. As illustrated in FIG. 15C, the insulating layer 22 is formed from the paste 32, and the metal base layer 21 is formed from the paste 34. The insulating layer 22 is a glass layer, which is an inorganic insulator containing, for example, silicon oxide and a metal oxide, and is amorphous.

Next, in step S26 of FIG. 5, the plating layers 24 are formed. Thus, the plating layers 24 are formed to cover the metal base layer 21, thereby forming the multilayer ceramic capacitor 100 of FIG. 4.

In accordance with a range in which the paste 32 is applied in FIG. 15B, a region in which the insulating layer 22 is formed can be appropriately set. For example, as in FIGS. 12 and 14 of Modified Examples 2 and 4 of the second embodiment, the insulating layer 22 may be disposed on the −X side of the metal base layer 21 to be apart from the metal base layer 21. As in FIG. 12 of Modified Example 3 of the second embodiment, a portion of the insulating layer 22 may be disposed on the surface of the metal base layer 21.

As in the third embodiment, in which the insulating layer 22 is a glass layer, diffusion of hydrogen can be further suppressed.

In the embodiments, the recitation that a member containing an element or molecule as a main component refers to the member containing the element or molecule in an amount that exhibits the effects of the embodiments. The concentration of the element or molecule in the member is, for example, 50% by mole or more, 80% by mole or more, or 90% by mole or more.

Although the embodiments have been described above in detail, the present disclosure is not limited to the specific embodiments, and various modifications and alterations are possible within the scope of claims recited.

The embodiments disclosed above include, for example, the following.
<1> A multilayer ceramic electronic component, including:
a body that includes a plurality of internal electrodes and a plurality of dielectric layers, and includes end surfaces facing each other, in which each of the plurality of dielectric layers includes a ceramic as a main component, and the plurality of internal electrodes and the plurality of dielectric layers are alternately laminated;
a metal base layer that is in contact with at least a portion of the plurality of internal electrodes exposed from at least one end surface of the end surfaces of the body, and is disposed at an end portion of a surface of the body connected to the at least one end surface, the end portion being on an end-surface side of the body;
an insulating layer that is disposed opposite to the at least one end surface across an end of the metal base layer at the end portion; and
a plating layer disposed at the end portion such that the metal base layer and the insulating layer are sandwiched between the plating layer and the body, the plating layer forming an external electrode with the metal base layer.
<2> The multilayer ceramic electronic component according to <1>, wherein
the plating layer includes a nickel plating layer including nickel as a main component, and
the nickel plating layer is not in contact with the body.
<3> The multilayer ceramic electronic component according to <2>, wherein
at least a portion of the plating layer other than the nickel plating layer is in contact with the body.
<4> The multilayer ceramic electronic component according to any one of <1> to <3>, further including:
a metal layer that is disposed between the metal base layer and the plating layers, and is continuous with the insulating layer, wherein
the insulating layer includes a metal element of a main component of the metal layer.
<5> The multilayer ceramic electronic component according to <4>, wherein
the insulating layer includes, as a main component, an oxide or nitride of the metal element.
<6> The multilayer ceramic electronic component according to <4>, wherein
the metal layer includes tin as a main component, and
the insulating layer includes tin oxide as a main component.
<7> The multilayer ceramic electronic component according to any one of <1> to <6>, wherein
the insulating layer is a glass layer.
−8> The multilayer ceramic electronic component according to any one of <1> to <7>, wherein
the insulating layer is not disposed between the metal base layer and the body in a region that is 1 μm or more apart from the end of the metal base layer toward the at least one end surface.
<9> A production method of a multilayer ceramic electronic component, the production method including:
providing a body that includes a plurality of internal electrodes and a plurality of dielectric layers, and includes end surfaces facing each other, in which each of the plurality of dielectric layers includes a ceramic as a main component, and the plurality of internal electrodes and the plurality of dielectric layers are alternately laminated;
forming a metal base layer that is in contact with at least a portion of the plurality of internal electrodes exposed from at least one end surface of the end surfaces of the body, and is disposed at an end portion of a surface of the body connected to the at least one end surface, the end portion being on an end-surface side of the body;
forming an insulating layer that is disposed opposite to the at least one end surface across an end of the metal base layer at the end portion; and
forming a plating layer disposed at the end portion such that the metal base layer and the insulating layer are sandwiched between the plating layer and the body, the plating layer forming an external electrode with the metal base layer.
<10> The production method according to <9>, wherein
the formation of the insulating layer includes:
   forming a metal layer that covers the metal base layer and the body opposite to the at least one end surface across the end of the metal base layer at the end portion, and
   forming the insulating layer by performing oxidation or nitridation of a region of the metal layer opposite to the at least one end surface across the end of the metal base layer.
<11> The production method according to <10>, wherein
the formation of the insulating layer by performing the oxidation or nitridation of the region of the metal layer includes:
   oxidizing the region of the metal layer by irradiating the region of the metal layer with laser light.

What is claimed is:

1. A multilayer ceramic electronic component, comprising:
a body that includes a plurality of internal electrodes and a plurality of dielectric layers, and includes end surfaces facing each other, in which each of the plurality of dielectric layers includes a ceramic as a main component, and the plurality of internal electrodes and the plurality of dielectric layers are alternately laminated;
a metal base layer that is in contact with at least a portion of the plurality of internal electrodes exposed from at least one end surface of the end surfaces of the body, and is disposed at an end portion of a surface of the body connected to the at least one end surface, the end portion being on an end-surface side of the body;
an insulating layer that is disposed opposite to the at least one end surface across an end of the metal base layer at the end portion; and
a plating layer disposed at the end portion such that the metal base layer and the insulating layer are sandwiched between the plating layer and the body, the plating layer forming an external electrode with the metal base layer.

2. The multilayer ceramic electronic component according to claim 1, wherein
the plating layer includes a nickel plating layer including nickel as a main component, and
the nickel plating layer is not in contact with the body.

3. The multilayer ceramic electronic component according to claim 2, wherein
at least a portion of the plating layer other than the nickel plating layer is in contact with the body.

4. The multilayer ceramic electronic component according to claim 1, further comprising:
a metal layer that is disposed between the metal base layer and the plating layers, and is continuous with the insulating layer, wherein
the insulating layer includes a metal element of a main component of the metal layer.

5. The multilayer ceramic electronic component according to claim 4, wherein
the insulating layer includes, as a main component, an oxide or nitride of the metal element.

6. The multilayer ceramic electronic component according to claim 4, wherein
the metal layer includes tin as a main component, and
the insulating layer includes tin oxide as a main component.

7. The multilayer ceramic electronic component according to claim 1, wherein
the insulating layer is a glass layer.

8. The multilayer ceramic electronic component according to claim 1, wherein
the insulating layer is not disposed between the metal base layer and the body in a region that is 1 μm or more apart from the end of the metal base layer toward the at least one end surface.

9. A production method of a multilayer ceramic electronic component, the production method comprising:
providing a body that includes a plurality of internal electrodes and a plurality of dielectric layers, and includes end surfaces facing each other, in which each of the plurality of dielectric layers includes a ceramic as a main component, and the plurality of internal electrodes and the plurality of dielectric layers are alternately laminated;
forming a metal base layer that is in contact with at least a portion of the plurality of internal electrodes exposed from at least one end surface of the end surfaces of the body, and is disposed at an end portion of a surface of the body connected to the at least one end surface, the end portion being on an end-surface side of the body;
forming an insulating layer that is disposed opposite to the at least one end surface across an end of the metal base layer at the end portion; and
forming a plating layer disposed at the end portion such that the metal base layer and the insulating layer are sandwiched between the plating layer and the body, the plating layer forming an external electrode with the metal base layer.

10. The production method according to claim 9, wherein
the formation of the insulating layer includes:
forming a metal layer that covers the metal base layer and the body opposite to the at least one end surface across the end of the metal base layer at the end portion, and
forming the insulating layer by performing oxidation or nitridation of a region of the metal layer opposite to the at least one end surface across the end of the metal base layer.

11. The production method according to claim 10, wherein
the formation of the insulating layer by performing the oxidation or nitridation of the region of the metal layer includes:
oxidizing the region of the metal layer by irradiating the region of the metal layer with laser light.
